(19) United States
(12) Patent Application Publication
(10) Pub. No.: US 2025/0054691 A1
(43) Pub. Date: Feb. 13, 2025

(54) CARBONIZED CELLULOSE FIBER ELECTRODES FOR HIGH-FREQUENCY ELECTROCHEMICAL CAPACITORS AND METHOD FOR FABRICATING THE SAME

(71) Applicant: Zhaoyang FAN, Phoenix, AZ (US)

(72) Inventor: Zhaoyang FAN, Phoenix, AZ (US)

(73) Assignee: Arizona Board of Regents on Behalf of Arizona State University, Scottsdale, AZ (US)

(21) Appl. No.: 18/799,891

(22) Filed: Aug. 9, 2024

Related U.S. Application Data
(60) Provisional application No. 63/519,183, filed on Aug. 11, 2023.

(51) Int. Cl. H01G 4/008; H01G 4/01

(52) U.S. Cl. CPC H01G 4/008; H01G 4/01

(57) ABSTRACT

Carbonized cellulose fiber electrodes for high-frequency electrochemical capacitors and method for fabricating the same is disclosed. The method includes carbonizing a cellulose fiber substrate by subjecting the cellulose fiber substrate to a rapid pyrolysis process in a preheated furnace having an inert environment at a pyrolysis temperature of at least 1000° C., resulting in a carbonized cellulose substrate. The method also includes preparing a hydrothermal solution, and depositing vertically oriented nanoflakes on the carbonized cellulose substrate by immersing the carbonized cellulose substrate in the hydrothermal solution and conducting a hydrothermal reaction, thereby forming the electrode. The vertically oriented nanoflakes may be composed of MoS₂. The cellulose fiber substrate may be a cellulose tissue sheet. The electrochemical capacitor includes at least two electrodes, each having vertically oriented nanoflakes deposited on a carbonized cellulose substrate, and an electrolyte positioned between each pair of the at least two electrodes.

### RELATED APPLICATIONS

This application claims the benefit of U.S. provisional patent application 63/519,183, filed Aug. 11, 2023, titled “Carbonized Cellulose Fiber and its Composites for Ultrafast Electrochemical Capacitors,” the entirety of the disclosure of which is hereby incorporated by this reference.

### STATEMENT REGARDING FEDERALLY SPONSORED RESEARCH

This invention was made with government support under 2122921 awarded by the National Science Foundation. The government has certain rights in the invention.

### TECHNICAL FIELD

Aspects of this document relate generally to electrodes for electrochemical capacitors.

### BACKGROUND

Supercapacitors, or electrochemical capacitors (ECs), are renowned for their high power density and long cycle life. They operate by storing charge in the electric double layers at the electrolyte-electrode interface, facilitating rapid charge and discharge cycles. These features make them suitable for energy storage, pulse power delivery, and filtering applications. However, traditional supercapacitors face significant challenges in high-frequency applications. The design and material properties, such as tortuous pores in electrode materials, limit their operable frequency range to below 1 Hz, impeding their efficiency in high-frequency filtering and energy storage.

High-frequency electrochemical capacitors (HF-ECs) are being developed to meet the increasing demands of miniaturized electronic devices and their power sources. These capacitors are intended to replace aluminum electrolytic capacitors (AECs) in applications requiring high capacitance density and efficient performance at kilohertz frequencies. AECs, despite their ubiquity in AC/DC and DC/DC conversions and pulse power generation, suffer from intrinsic limitations such as low capacitance and energy densities, as well as issues with size, lifetime, and performance under varying temperatures and voltages.

Recent advancements in electrode materials have aimed to overcome the limitations of conventional ECs. High-performance materials such as graphene, carbon nanotubes, carbon nanofibers, and other conductive nanomaterials like MXenes and TiN have been employed to enhance the performance of HF-ECs. These materials are characterized by open pore structures that balance capacitance and response frequency, enabling better performance in high-frequency applications. Notably, vertically oriented graphene flakes deposited on carbonized cellulose sheets have shown promise in fabricating high-performance filtering ECs. Despite these advancements, the scalability and cost-effectiveness of these materials remain significant challenges.

The production of supercapacitors using advanced materials often involves complex and hazardous processes, raising environmental and scalability concerns. Techniques such as plasma enhanced chemical vapor deposition (PECVD) used for fabricating vertically oriented graphene pose limitations for large-scale, low-cost production. Additionally, the high internal resistance in traditional supercapacitors results in considerable energy losses during high-frequency operations, which affects their efficiency in applications requiring capacitive response at 120 Hz and higher harmonic frequencies.

The market for filtering capacitors is vast, encompassing applications from consumer electronics to renewable energy and emerging technologies like IoT and wearable devices. There is a critical need for new capacitor technologies that offer reduced size, higher reliability, and better performance, yet also make use of fabrication techniques that are scalable and cost-effective.

### SUMMARY

According to one aspect, a method for making an electrode includes carbonizing a cellulose fiber substrate by subjecting the cellulose fiber substrate to a rapid pyrolysis process in a preheated furnace having an inert environment at a pyrolysis temperature of at least 1000° C., resulting in a carbonized cellulose substrate. The method also includes preparing a hydrothermal solution, and depositing vertically oriented nanoflakes on the carbonized cellulose substrate by immersing the carbonized cellulose substrate in the hydrothermal solution and conducting a hydrothermal reaction, thereby forming the electrode.

Particular embodiments may comprise one or more of the following features. The vertically oriented nanoflakes may be composed of a transition metal dichalcogenide. The transition metal dichalcogenide may be MoS₂. The hydrothermal solution may be prepared by dissolving sodium molybdate dihydrate and thiourea in deionized water. The hydrothermal reaction may be conducted at a hydrothermal temperature of at least 220° C. for a hydrothermal duration between 2 and 3 hours. The cellulose fiber substrate may be a cellulose tissue sheet. The cellulose fiber substrate may be subjected to the rapid pyrolysis process for a pyrolysis duration of less than 20 minutes with the pyrolysis temperature above 1000° C. The electrode may be freestanding. The electrode may be at most 10 μm thick. The vertically oriented nanoflakes may be composed of a transition metal oxide. The vertically oriented nanoflakes may be composed of one of a transition metal nitride and a 2D MXene. The vertically oriented nanoflakes may be composed of graphene. The vertically oriented nanoflakes may be composed of carbon black.

According to another aspect of the disclosure, an electrochemical capacitor includes at least two electrodes, each having vertically oriented nanoflakes deposited on a carbonized cellulose substrate, and an electrolyte positioned between each pair of the at least two electrodes.

Particular embodiments may comprise one or more of the following features. The electrodes may have an areal capacitance density of at least 0.8 mF/cm² at 120 Hz. The vertically oriented nanoflakes may be composed of a transition metal dichalcogenide. The transition metal dichalcogenide may be MoS₂. The vertically oriented nanoflakes may be composed of a transition metal oxide. The vertically oriented nanoflakes may be composed of one of a transition metal nitride and a 2D MXene. The electrolyte may be an aqueous electrolyte. The electrolyte may be an organic electrolyte.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1 is a schematic process view of the fabrication of a carbonized cellulose fiber electrode for an ultrafast high-frequency electrochemical capacitor;

FIG. 2 is an exploded cross-sectional view of an ultrafast high-frequency electrochemical capacitor comprising carbonized cellulose fiber electrodes;

FIGS. 3A-3I are various SEM/TEM micrographs, XRD patterns, and XPS spectra for a specific embodiment of the carbonized cellulose fiber electrode;

FIGS. 4A-4F are various plots and spectra characterizing a specific embodiment of a high-frequency electrochemical capacitor with carbonized cellulose fiber electrodes and an aqueous electrolyte;

FIGS. 5A-5C are plots characterizing specific embodiments of the carbonized cellulose fiber electrode made with various hydrothermal growth times;

FIGS. 6A-6C are CV curves and plots characterizing a specific embodiment of a high-frequency electrochemical capacitor with carbonized cellulose fiber electrodes and an organic electrolyte;

FIG. 7A is a schematic view of an AC/DC full-wave conversion circuit using an HF-EC as the filtering capacitor;

FIGS. 7B-7F are simulations and characterizations of the circuit of FIG. 7A, demonstrating ripple filtering.

### DETAILED DESCRIPTION

This invention was made with government support under 2122921 awarded by the National Science Foundation. The government has certain rights in the invention.

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Supercapacitors, or electrochemical capacitors (ECs), are renowned for their high power density and long cycle life. They operate by storing charge in the electric double layers at the electrolyte-electrode interface, facilitating rapid charge and discharge cycles. These features make them suitable for energy storage, pulse power delivery, and filtering applications. However, traditional supercapacitors face significant challenges in high-frequency applications. The design and material properties, such as tortuous pores in electrode materials, limit their operable frequency range to below 1 Hz, impeding their efficiency in high-frequency filtering and energy storage.

High-frequency electrochemical capacitors (HF-ECs) are being developed to meet the increasing demands of miniaturized electronic devices and their power sources. These capacitors are intended to replace aluminum electrolytic capacitors (AECs) in applications requiring high capacitance density and efficient performance at kilohertz frequencies. AECs, despite their ubiquity in AC/DC and DC/DC conversions and pulse power generation, suffer from intrinsic limitations such as low capacitance and energy densities, as well as issues with size, lifetime, and performance under varying temperatures and voltages.

Recent advancements in electrode materials have aimed to overcome the limitations of conventional ECs. High-performance materials such as graphene, carbon nanotubes, carbon nanofibers, and other conductive nanomaterials like MXenes and TiN have been employed to enhance the performance of HF-ECs. These materials are characterized by open pore structures that balance capacitance and response frequency, enabling better performance in high-frequency applications. Notably, vertically oriented graphene flakes deposited on carbonized cellulose sheets have shown promise in fabricating high-performance filtering ECs. Despite these advancements, the scalability and cost-effectiveness of these materials remain significant challenges.

The production of supercapacitors using advanced materials often involves complex and hazardous processes, raising environmental and scalability concerns. Techniques such as plasma enhanced chemical vapor deposition (PECVD) used for fabricating vertically oriented graphene pose limitations for large-scale, low-cost production. Additionally, the high internal resistance in traditional supercapacitors results in considerable energy losses during high-frequency operations, which affects their efficiency in applications requiring capacitive response at 120 Hz and higher harmonic frequencies.

The market for filtering capacitors is vast, encompassing applications from consumer electronics to renewable energy and emerging technologies like IoT and wearable devices. There is a critical need for new capacitor technologies that offer reduced size, higher reliability, and better performance, yet also make use of fabrication techniques that are scalable and cost-effective.

Contemplated herein is a high-frequency electrochemical capacitor comprising carbonized cellulose fiber electrodes, and a method for making the same. The contemplated carbonized cellulose fiber electrode comprises vertically oriented nanoflakes (VON) deposited on carbonized cellulose (CC) sheets.

According to various embodiments, the ECs produced with these VON-CC electrodes demonstrate superior frequency response, high areal capacitance density, and scalability suitable for advanced electronic applications.

This is made possible by rapidly pyrolyzed cellulose sheets as a 3D carbon fiber scaffold, which provides interconnected conductive pathways essential for efficient electron transport. According to various embodiments, the carbonized cellulose scaffold acts as a substrate for the deposition of vertically oriented nanoflakes via a scalable hydrothermal process. The vertically oriented structure of the nanoflakes ensures minimized porosity effects, facilitating high-frequency ionic transport and enhancing overall capacitor performance.

According to various embodiments, the VON-CC electrodes are freestanding, eliminating the need for additional binders or current collectors. This simplification in device architecture not only reduces production complexity and cost but also enhances the reliability and efficiency of the capacitors.

Advantageous over conventional methods, the VON-CC based capacitors contemplated herein exhibit exceptional high-frequency performance, capable of effective ripple current filtering from 60 Hz to 60 kHz. The vertically oriented nanoflakes provide easily accessible atomic edges, increasing the charge storage capacity significantly when compared to traditional materials like graphene. The rapid pyrolysis process for carbonizing cellulose sheets and the subsequent hydrothermal deposition of nanoflakes result in a simple, cost-effective, and scalable fabrication method, according to various embodiments. The environmentally friendly production process avoids the use of hazardous chemicals and complex processing steps, making it more sustainable than traditional methods. Furthermore, the VON-CC electrodes achieve high areal capacitance densities, with demonstrated values of 0.8 mF/cm² at 120 Hz for MoS₂ nanoflakes, and maintain substantial capacitance at higher frequencies.

The fabrication methods for VON-CC based electrodes are significant advancements in the field of electrochemical capacitors, offering high-frequency response and scalability. The unique structure of the VON-CC electrodes addresses several limitations of traditional supercapacitors, providing a reliable and efficient solution for advanced electronic applications. The benefits provided by the VON-CC based capacitors stem, at least in part, from the combination of the rapid pyrolysis process and the hydrothermal deposition of vertically oriented nanoflakes. This architecture ensures efficient ionic transport, high areal capacitance density, and scalability, which are critical for high-frequency applications.

The VON-CC based capacitors contemplated herein may also have applications beyond high-frequency ripple current filtering. The compact, low-profile design is ideal for space-demanding applications such as portable electronics and environmental energy harvesting for wearable devices and IoT sensors. The high efficiency and adaptability of these capacitors make them suitable for a wide range of advanced electronic applications, addressing the critical requirements of scalability, cost-effectiveness, and environmental sustainability.

In the context of the present description and the claims that follow, “vertically oriented” refers to the orientation of the nanoflake relative to the substrate plane (e.g., a tangent plane of the surface of a fiber in the carbonized cellulose, etc.). If the flake is perpendicular to the substrate plane (regardless of the plane's actual orientation with respect to gravity), it's called vertical orientation. If it's parallel to the substrate, it's called lateral orientation. In the context of the present description and the claims that follow, perpendicular, as pertains to determining if a structure is “vertically oriented”, means closer to perpendicular than to parallel.

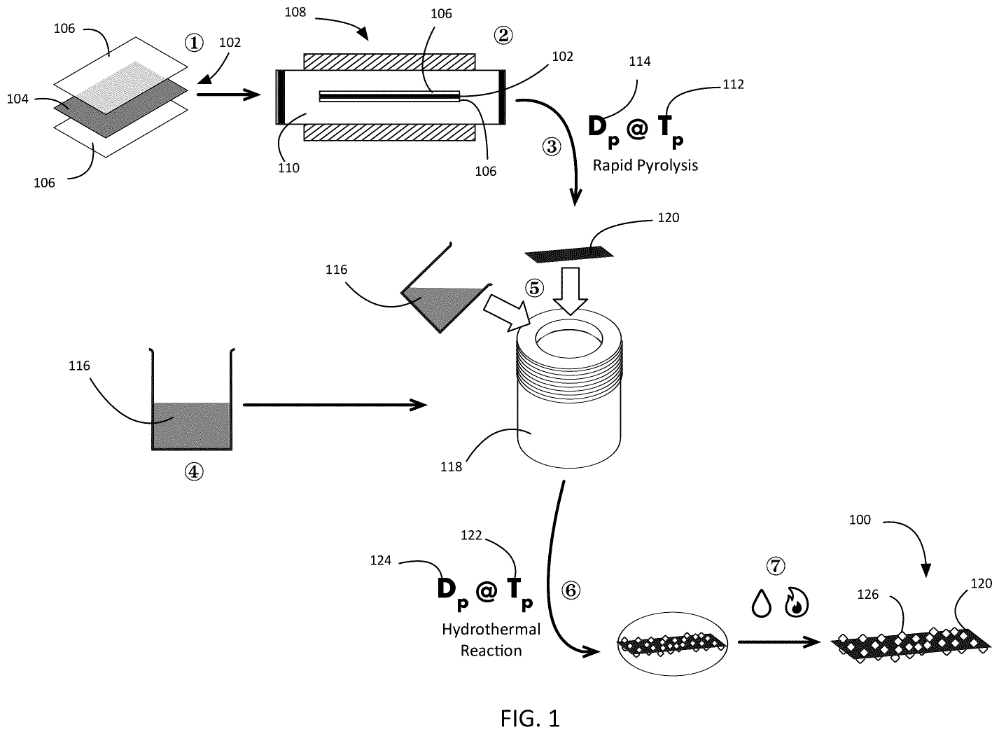

In the context of the present description and the claims that follow, carbonized cellulose (CC) substrate is cellulose material (e.g., cellulose tissue sheets, etc.) transformed into conductive carbon fiber scaffolds through a rapid pyrolysis process, as will be discussed in the context of FIG. 1, below. Additionally, in the context of the present description and the claims that follow, the hydrothermal process is a method of depositing nanomaterials on a substrate using high-temperature aqueous solutions, which is scalable and cost-effective.

A “nanoflake” is a term related to 2D materials, like graphene. Ideally, graphene has only one atomic layer, but they commonly exist as a few or multiple layers. Other 2D materials, including those used in the contemplated electrodes and capacitors, are similar. It should be noted that even with multiple layers, their thickness is still much smaller than their lateral area (i.e., a high aspect ratio), so they are referred to as “flakes”. If their lateral dimension is less than one micrometer, they are called “nanoflakes”.

Much of the following discussion, including specific embodiments that have been experimentally characterized, will be done in the context of a carbonized cellulose fiber electrode comprising vertically oriented nanoflakes composed of MoS₂. Vertically oriented MoS₂ (VOM) nanoflakes are a nanostructure of molybdenum disulfide with vertical alignment, providing enhanced ionic transport pathways. Other embodiments of the contemplated carbonized cellulose fiber electrodes make use of different materials. Exemplary nanoflake materials include, but are not limited to, transition metal dichalcogenides or TMDs (e.g., MoS₂, WS₂, MoSe₂, WSe₂, etc.), two-dimensional transition metal oxides (e.g., TiO₂, MoO₃, WO₃, etc.), 2D transition metal nitrides (e.g., TiN, VN, etc.), 2D MXenes (e.g. Ti₃C₂Tₓ), carbon black, and vertical graphene. In addition to nanoscale two dimensional geometry, the material should have reasonable conductivity (e.g. greater than 10 S/cm), according to various embodiments.

FIG. 1 is a schematic process view of a non-limiting example of a method for fabricating a carbonized cellulose fiber electrode 100. This non-limiting example will be discussed in terms of various embodiments and variations. This discussion will be accompanied by a more detailed description of a specific embodiment that will be discussed throughout.

First, a cellulose fiber substrate 102 is subjected to rapid pyrolysis. According to various embodiments, the cellulose fiber substrate 102 is first sandwiched between two quartz plates 106. See ‘circle 1’.

In the context of the present description and the claims that follow, a cellulose fiber substrate 102 is a cellulose-based fibrous material. In some embodiments, the cellulose fiber substrate 102 may be a cellulose tissue sheet 104 (e.g., KIMTECH Kimwipe, etc.). In other embodiments, other forms of cellulose fiber substrate 102 may be used. In the specific embodiment, the cellulose fiber substrate 102 is a KIMTECH Kimwipe cellulose tissue sheet 104, used as obtained without any purification.

Next, the cellulose fiber substrate 102 is placed in a furnace 108 capable of creating an inert environment 110 (e.g., an argon environment). See ‘circle 2’. The furnace 108 is preheated before the cellulose fiber substrate 102 is inserted, according to various embodiments. In the specific embodiment, a quartz tube furnace is used, with an argon environment.

The cellulose fiber substrate 102 is then quickly carbonized through rapid pyrolysis. See ‘circle 3’. Specifically, the cellulose fiber substrate 102 is subjected to a pyrolysis temperature 112 for a pyrolysis duration 114, within the inert environment 110, according to various embodiments.

The carbonization of the cellulose sheets is an important step and has a large effect on the frequency response of the capacitor. Reduction of carbon precursors and partial graphitization can generate inter-connected conductive pathways for effective electron transport.

Two key parameters for electrodes of HF-EC are: conductivity (high) and porosity (low). A 3rd parameter Hydrophilicity may also be important, depending on what solvent is used when making the capacitor.

Cellulose is composed of C, O, and H, and is nonconductive. Carbonization will make it conductive by getting rid of O and H. To further improve the conductivity, high carbonization temperatures are needed. Common carbonization is conducted at temperatures greater than 500° C., typically for several hours. With all O and H driven out, the conductivity is improved, but the material is left with lots of micropores. These micropores are good for large capacitance, but limit the frequency response. With all O and H driven out, the pure carbon is highly hydrophobic, while most solvents (e.g., water, acetonitrile, DMSO, etc.) require the electrode to be hydrophilic.

Instead of the usual slow pyrolysis, the carbonized cellulose substrate 120 contemplated herein is fabricated using a rapid carbonization process, according to various embodiments. Rapid carbonization at a high pyrolysis temperature 112 with a short pyrolysis duration 114 results in a reasonably good conductivity with low microporosity and hydrophilicity due to the small amount of O, H remaining.

However, while rapid pyrolysis will avoid the formation of high density micropores and the accompanying frequency problems, this process can also leave the capacitance density is low. Now combining “vertical 2D nanoflakes” with “rapid carbonization of cellulose fiber sheets”, a high frequency response and large capacitance density can be achieved simultaneously.

In some embodiments, the pyrolysis temperature 112 may be 1000° C. In other embodiments, the pyrolysis temperature 112 may be higher. As the temperature goes up, the pyrolysis duration 114 can come down. For example, in one embodiment, the cellulose fiber substrate 102 may be carbonized at 1000° C. for 20 minutes. In another embodiment, the pyrolysis temperature 112 may be greater than 1000° C. while the pyrolysis duration 114 is less than 20 minutes. In still another embodiment, the pyrolysis temperature 112 may rise to 1200° C. and the pyrolysis duration 114 may drop to 5 minutes. In other embodiments, the pyrolysis may be terminated based on a determination of how much oxygen remains in the cellulose fiber substrate 102, or what the conductivity is, rather than using time. As a specific example, in one embodiment, the rapid pyrolysis may be carried out until the resistivity of the carbonized cellulose fiber substrate is less (2·cm. In the specific embodiment, the cellulose tissue sheet 104 is carbonized at 1000° C. for 20 minutes.

The obtained black films are carbonized cellulose substrate 120, also referred to as CC, on which vertically oriented nanoflakes will be grown.

Next, the hydrothermal solution 116 is prepared. See ‘circle 4’. The contents of the hydrothermal solution 116 will vary from one embodiment to another, depending on the material being used for the vertically oriented nanoflakes 126. In the specific embodiment, the vertically oriented nanoflakes 126 are composed of MoS₂. In that specific embodiment, the hydrothermal solution 116 is prepared by dissolving 0.5 g sodium molybdate dihydrate (i.e., from ACROS Organics, 99+%) and 0.75 g of thiourea (i.e., from Thermo Fisher Scientific, 99+%) in 30 ml of deionized (DI) water.

It should be noted that while in some embodiments, a hydrothermal reaction may be utilized, in other embodiments a different process may be used for depositing nanoflakes on the carbonized cellulose substrate 120. For example, in one embodiment, vertically oriented graphene nanoflakes can be formed on carbonized cellulose substrate 120 using chemical vapor deposition.

The hydrothermal solution 116 is loaded into a hydrothermal reactor 118 (e.g., a Teflon-lined autoclave, etc.), and the carbonized cellulose substrate 120 is immersed in the hydrothermal solution 116. See ‘circle 5’.

Next, the hydrothermal reaction is performed. See ‘circle 6’. According to various embodiments, the vertical alignment of the nanoflakes is a property that manifests because of a hydrothermal reaction. According to various embodiments, the hydrothermal reaction is carried out at a hydrothermal temperature 122 for a hydrothermal duration 124, growing the vertically oriented nanoflakes 126 on the carbonized cellulose substrate 120.

According to various embodiments, the hydrothermal reaction may be conducted at a hydrothermal temperature 122 of at least 220° C. for a hydrothermal duration 124 between 2 and 3 hours. This is followed by a 6 hour cooldown, in some embodiments.

The hydrothermal duration 124 controls the amount of vertically oriented nanoflakes 126 deposited on the carbonized cellulose substrate 120, and can have a large impact on the resulting HF-EC performance. This will be discussed in greater detail in the context of the specific embodiment, where different samples were grown for different lengths of time. When discussing this specific embodiment, which comprises vertically oriented MoS₂ nanoflakes (VOM), the samples will be named as follows: VOM-CC-2h for 2 h growth (i.e., the hydrothermal duration 124), VOM-CC-2h15m for 2 h 15 min growth, and so forth.

According to various embodiments, the contents of the hydrothermal reactor 118 are carefully removed, and the resulting film is washed and dried. See ‘circle 7’. In the specific embodiment, the film is washed three times with D1 water and two times with ethanol. The film is then dried on a hot plate at 60° C. for 30 minutes before heating inside a vacuum oven overnight at 80° C. In some embodiments, the vertically oriented nanoflakes 126 may be treated with plasma to enhance their conductivity, as an option.

The resulting carbonized cellulose fiber electrode 100 comprises vertically oriented nanoflakes 126 deposited on a carbonized cellulose substrate 120. In some embodiments, including the specific embodiment, the electrode 100 may have a thickness of, at most, 10 μm and can be directly used as a freestanding electrode to assemble ECs.

In the specific embodiment, the obtained film electrode 100 is vertically oriented MoS₂ nanoflakes (VOM) on carbonized cellulose (CC) microfibers, abbreviated VOM-CC-2h. Reactions were also carried out for a reaction time of 2 hr 5 min, 2 hr 10 min, 2 h 15 min, 2 hr 30 min, and 3 hr. The obtained film electrodes were abbreviated as VOM-CC-2h5m, VOM-CC-2h10m, VOM-CC-2h15m and similarly for the rest.

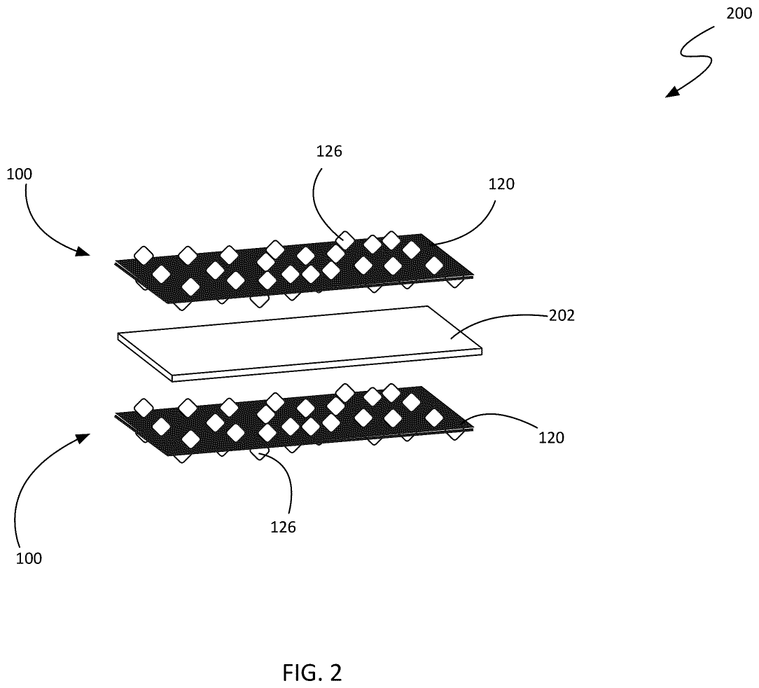

FIG. 2 is an exploded cross-sectional view of a non-limiting example of a high-frequency electrochemical capacitor 200 comprising an electrolyte 202 sandwiched between each pair of carbonized cellulose fiber electrodes 100. As previously mentioned, the specific embodiment using MoS₂ and carbonized Kimwipes was fabricated and characterized. Based on its open morphology and highly ion-accessible nanostructure, VOM-CC-2h was tested as the electrode for fabrication of HF-ECs. Cells with a symmetric two-electrode configuration were assembled inside coin cells with 6M KOH as the aqueous electrolyte. Electrochemical impedance spectroscopy (EIS) and cyclic voltammetry (CV) were conducted to evaluate the performance of the devices.

The following is a discussion of the characterization of the specific embodiment of the contemplated carbonized cellulose fiber electrode 100 discussed above, comprising MoS₂ nanoflakes. It will be variations of VOM-CC-2h (the variation being, in one case, different values for the hydrothermal duration 124). The characterization was performed on the specific embodiment, both as an electrode 100 and as part of a high-frequency electrochemical capacitor 200.

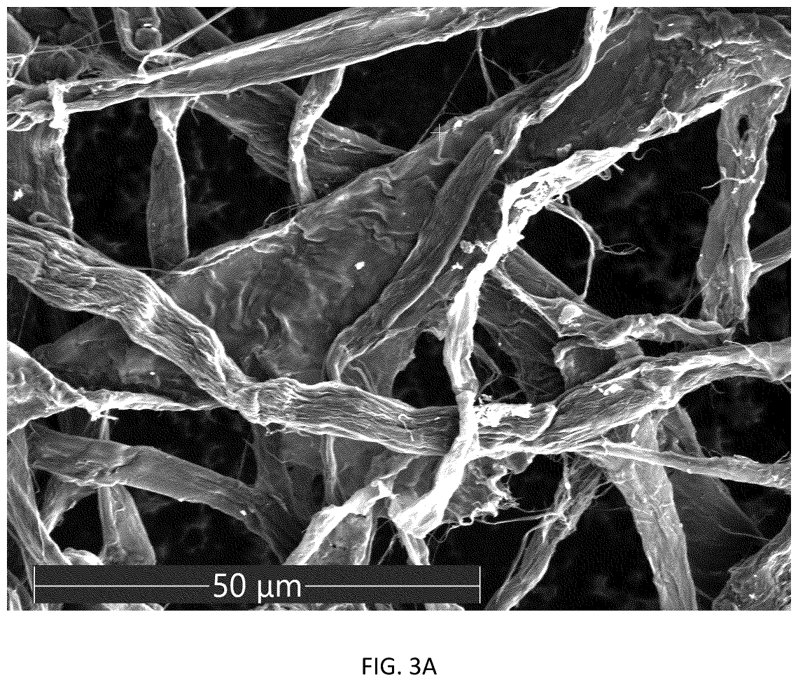

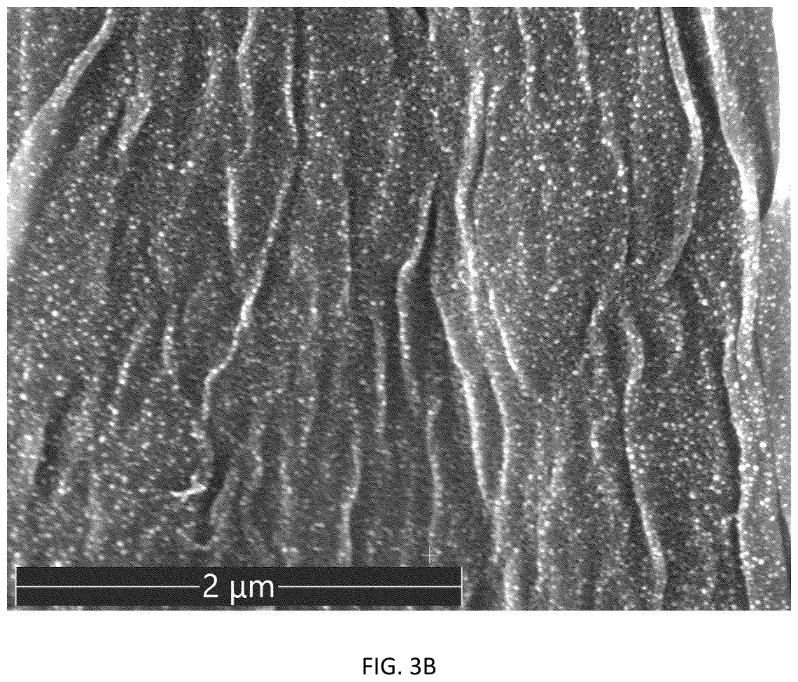

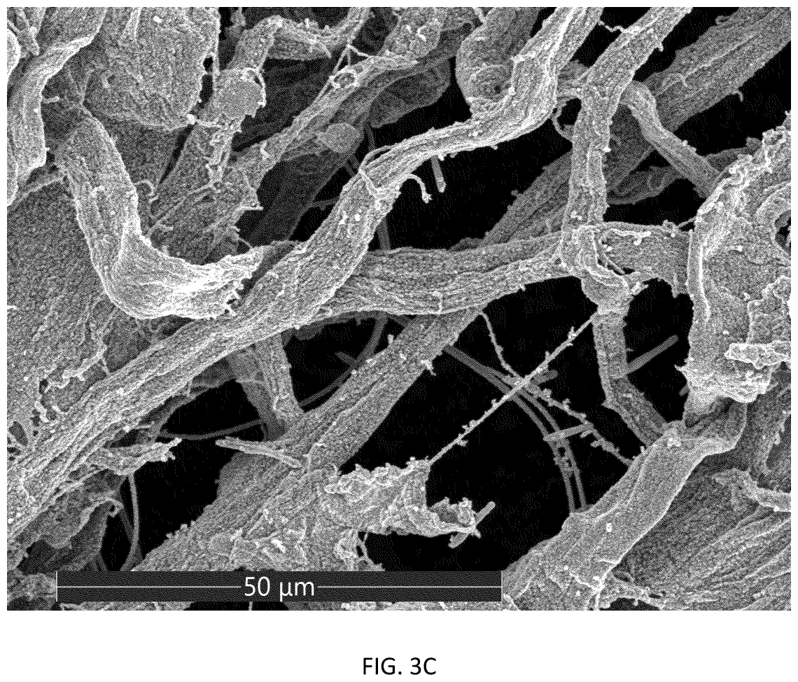

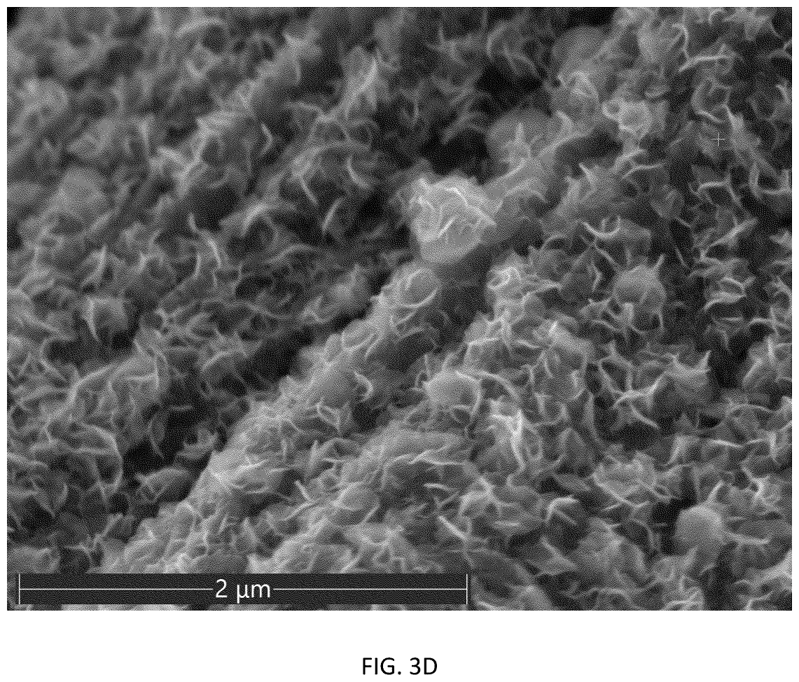

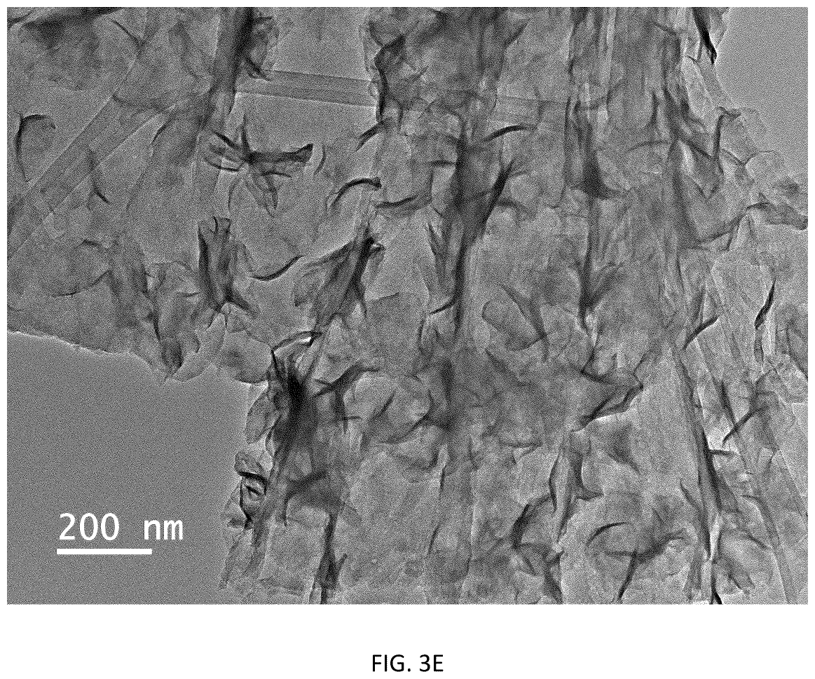

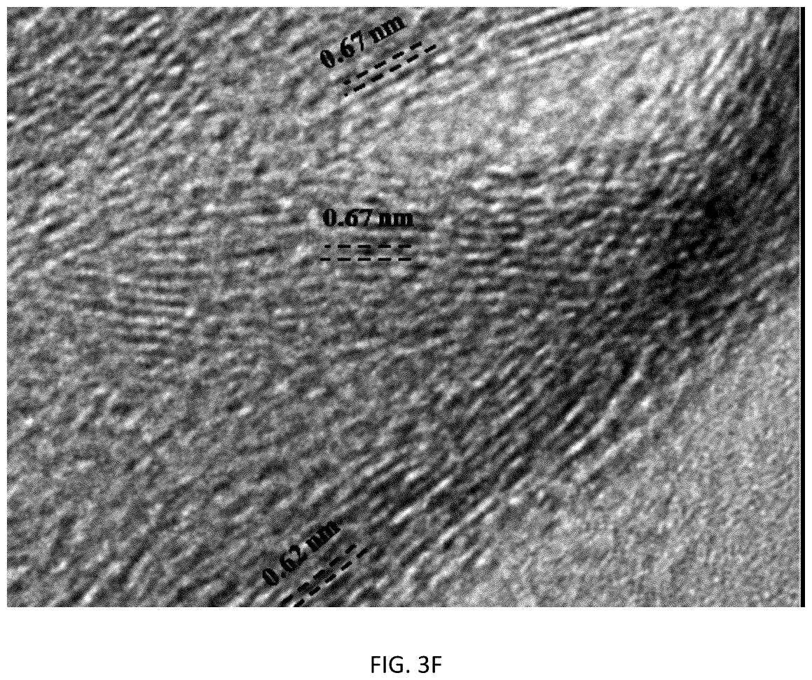

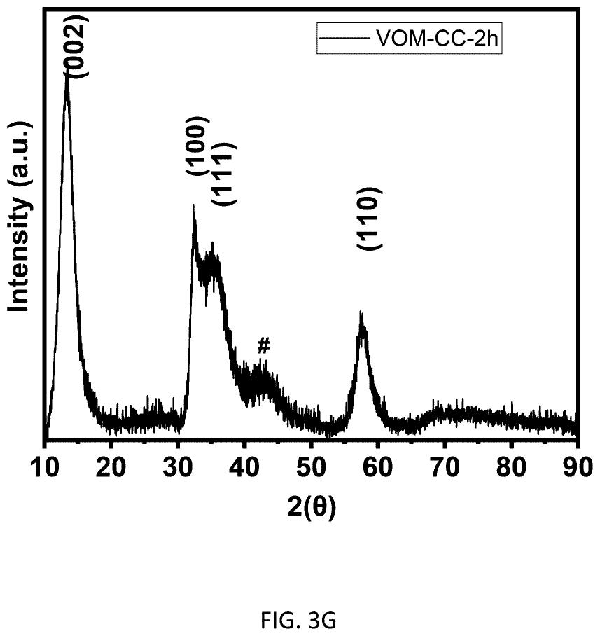

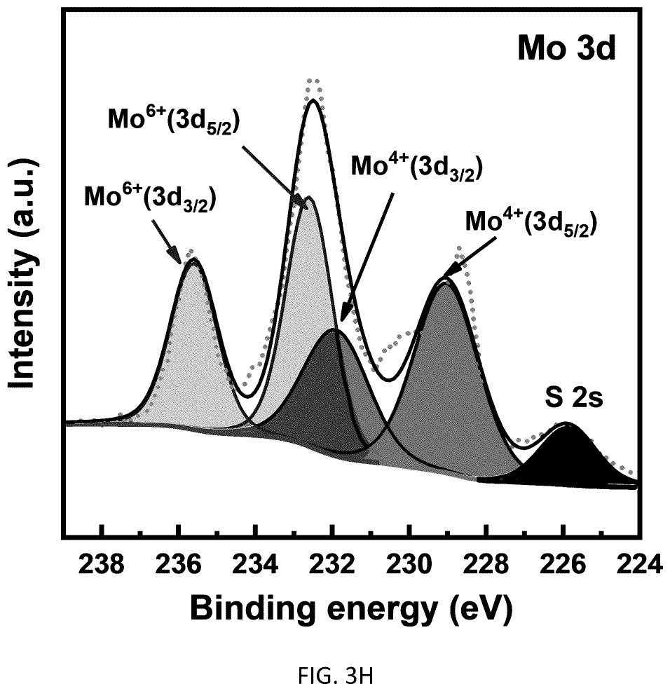

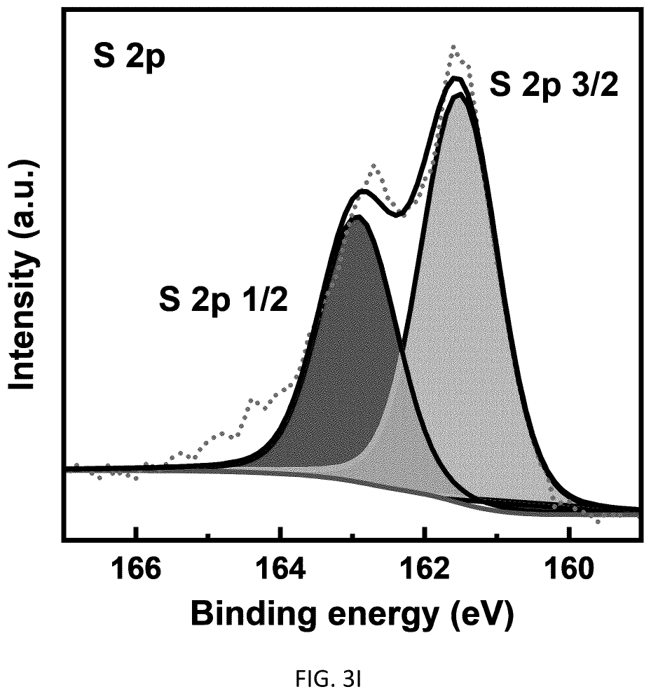

FIGS. 3A-3I are various SEM/TEM micrographs, XRD patterns, and XPS spectra for a specific embodiment of the carbonized cellulose fiber electrode. Specifically, FIGS. 3A-3D are SEM micrographs of CC(FIGS. 3A and 3B) and VOM-CC-2h (FIGS. 3C and 3D). FIGS. 3E and 3F are TEM micrographs. FIG. 3G is an XRD pattern. FIGS. 3H and 3I are XPS spectra of Mo 3d (FIG. 3H) and S 2p (FIG. 3I) for the VOM-CC-2h sample.

Microscopic imaging for analyzing the morphology and crystalline structure of VOM-CC films was accomplished using a Helios 5 UX scanning electron microscope (SEM) and a JEOL 2010F transmission electron microscope (TEM). X-ray diffraction analysis was conducted using Cu Ka radiation (λ=0.1541 nm) on an X-ray Diffractometer (Malvern PANalytical Aeris). X-ray photoelectron spectroscopy (XPS) data were acquired using a spectrometer (Krator Axis Supra+apparatus). The photoelectrons were excited by monochromatic Al Ka radiation (hv=1486.6 eV), and the high-resolution spectra were acquired with a step of 0.1 eV and the pass energy of 23.5 eV. To correct for sample charging, the binding energy (BE) of spectra was referenced to the adventitious carbon C Is BE at 284.8 eV.

The microstructures of CC (i.e., carbonized cellulose substrate 120) and VOM-CC (i.e., carbonized cellulose fiber electrode 100 using MoS₂) were observed using a scanning electron microscopy (SEM). The nonwoven CC (see FIGS. 3A and 3B) consists of flattened carbonized fiber bundles with different sizes, and the surface of the fiber bundle exhibits wrinkles. Between these fiber bundles are very large voids of tens of micrometers. For VOM-CC-2h, MoS₂ was deposited almost uniformly along all the fiber surfaces, and the geometry of the underlying CC scaffold had no obvious change (FIG. 3C). At a higher magnification (FIG. 3D), intersected MoS₂ nanoflakes, vertically aligned on the scaffold can be identified. The micrograph further shows sparse nanoflakes wrapped on the CC scaffold with ion readily accessible space between them.

When MoS₂ hydrothermal duration 124 was expanded from 2 hours to 3 hours, the morphology of MoS₂ layer was changed. Instead of a layer of sparse vertical nanoflakes that uniformly wrapped around individual carbon bundles, the nanoflakes became very dense and ball-like cluster features further appeared which were overgrown on the underlying MoS₂ nanoflakes. The increased nanoflake density and ball-like cluster formation certainly increases the MoS₂ mass loading and its surface area, however, the nanoflake surface now becomes difficult to access, limiting the frequency response of fabricated ECs. Therefore, they are not a favorable morphology for HF-ECs.

The transmission electron microscopy (TEM) imaging was also conducted to reveal the microscopic and layered structure of MoS₂ nanoflakes for CC-VOM-2h. The vertical nanoflake feature can be more clearly observed in FIG. 3E. The high-resolution TEM image (FIG. 3F) reveals the layered structure of MoS₂ nanoflakes. Each flake was formed by multiple atomic layers, and the flake thickness is in the range of few nm to a maximum of roughly 10 nm. The lattice spacing between atomic layers was found to be between 0.61 nm to 0.67 nm, corresponding to the d-spacing of the (002) plane of 2H-MoS₂ with a standard 0.61 nm value. The slightly expanded interlayer distance might be caused by Na⁺intercalation during the synthesis.

As can be appreciated, the freestanding VOM-CC electrode combines several unique features together, very suitable for developing HF-ECs. The oriented MoS₂ nanoflakes provide easily accessible atomic edges. Just like graphene, these atomic edges or steps have rich adsorption sites for electrolyte ions, and therefore, offer much higher charge storage capacity than its basal plane. The vertical orientation of MoS₂ flakes, with sub-μm flake height and wide opening network, minimizes the porosity effect which otherwise would restrict ionic transport and hence the high frequency response. The 3-D carbon fiber network offers a conductive interconnection between MoS₂ flakes to reduce the electrode resistance and provide a large surface area on a given footprint for MoS₂ deposition. Therefore, a large areal capacitance can be achieved.

The crystalline quality of the MoS₂ nanoflakes was further analyzed with x-ray diffractometry (XRD), as shown in FIG. 3G. The (013) peak at 39.5° and the (015) peaks at 49.8° which are the characteristic peaks for bulk MoS₂ are not observed which clearly represent the formation of layered MoS₂. The peaks at 13.4°, 32.3° and 57.3° can be referred to (002), (100) and (110) planes of 2H-MoS₂ respectively. In addition to this, (111) plane corresponding to 1T-MoS₂ is also observed at 35.0° and hence the coexistence of 2H and 1T phase of MoS₂ is inferred, i.e., 1T/2H-MoS₂. In 1T-MoS₂ phase, the partially filled d_{xy}/d_{yz}/d_{zx} degenerate orbitals provide metallic property to the material. The high electrical conductivity (10-100 Scm⁻¹) and hydrophilicity of the of 1T MoS₂ phase contribute to the high supercapacitive performance of 1T-MoS₂ electrode. The large anionic polarizability of S²⁻ due to their large ionic size which in turn leads to high ionic diffusivity in TMDCs is another factor positively impacting their pseudocapacitive performance. The d-spacing of 2H-MoS₂ for the (002) plane (20=13.4°) was also observed to be expanded to 0.66 nm due to the Na⁺intercalation. The coexistence of 1H and 2T structures causes a crystal strain inside the lattice which favorably activates the inert basal planes towards electrocatalytic activity allowing easier and efficient intercalation/deintercalation of cations from the electrolyte into the MoS₂ crystal. This allows faradic reactions to occur at very high rate at the electrode-electrolyte interface and therefore high capacitance values at high frequency may be expected from 1T/2H-MoS₂ nanoflakes.

X-ray photoelectron spectroscopy (XPS) was utilized to investigate the chemical composition and oxidation states of elements in MoS₂ nanocomposites. The XPS wide survey analysis confirms the presence of Mo and S on the carbon surface. The atomic percentage (at %) of Mo was determined to be 15.45 at % for VOM-CC-2h5m, higher than the 9.74 at % for VOM-CC-2h, indicating an increased loading of MoS₂ with longer growth time. To measure the binding energies of Mo and S atoms, high-resolution XPS analysis was conducted. There exist three distinct Mo 3d peaks at 229.1, 232.2, and 235.9 eV (FIG. 3H), which were further deconvoluted into two separate overlapping doublets. The first doublet peaks, appearing at lower binding energy (228.8 eV and 231.8 eV), were attributed to the 4+oxidation state of Mo, corresponding to Mo⁴⁺ (3d_{5/2}) and Mo⁴⁺ (3d_{3/2}), with an electron spin-orbit splitting of 3.1 eV. Meanwhile, the second doublet peaks observed at higher binding energy (232.3 eV and 235.9 eV) were attributed to the Mo (6+) oxidation state, corresponding to Mo⁶⁺ (3d_{5/2}) and Mo⁶⁺ (3d_{3/2}), respectively. This indicates a certain degree of oxidation occurring on the sample surface. Additionally, a small S 2s peak was observed at 226.2 eV. The deconvolution of the S 2p spectra shown in FIG. 3I revealed a S 2p 3/2 peak at 161.9 eV and a S 2p 1/2 peak at 163.1 eV, exhibiting a spin-orbit splitting ratio closer to 2:3 rather than the 1:2 ratio characteristic of elemental sulfur. This finding further supports the existence of the S²-oxidation state in the 2h-MoS₂ composite. These results are in good agreement with reported data for MoS₂ materials. In the case of the COM-CC-2h5m sample, the intensity of Mo⁶⁺peaks slightly decreased, while the signal of Mo⁴⁺peaks increased with longer deposition time. The suppression of the Mo⁶⁺peak indicates that the Mo⁶⁺peaks primarily originated from the surface oxidation of MoS₂.

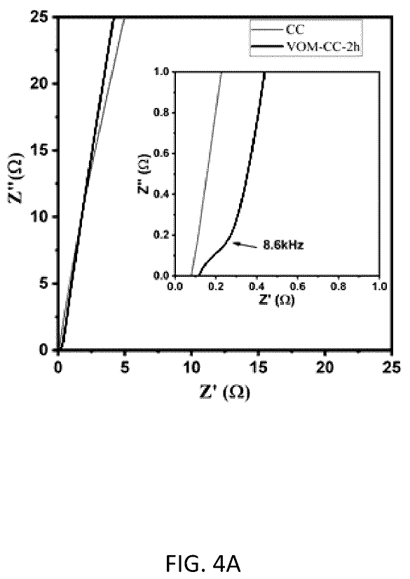

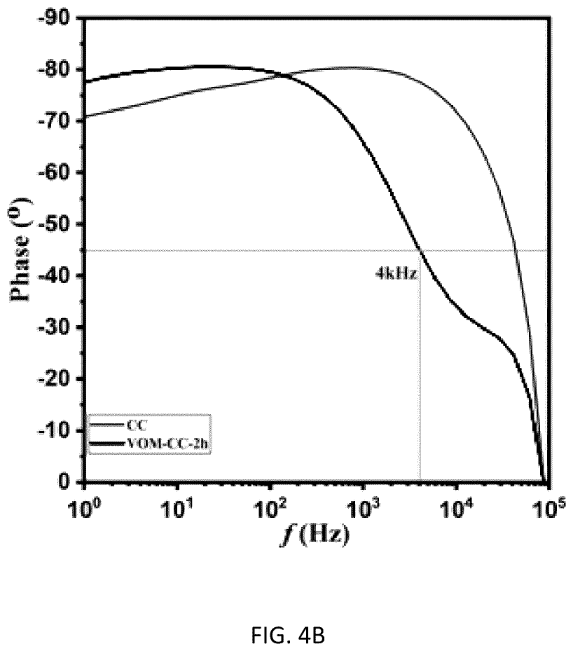

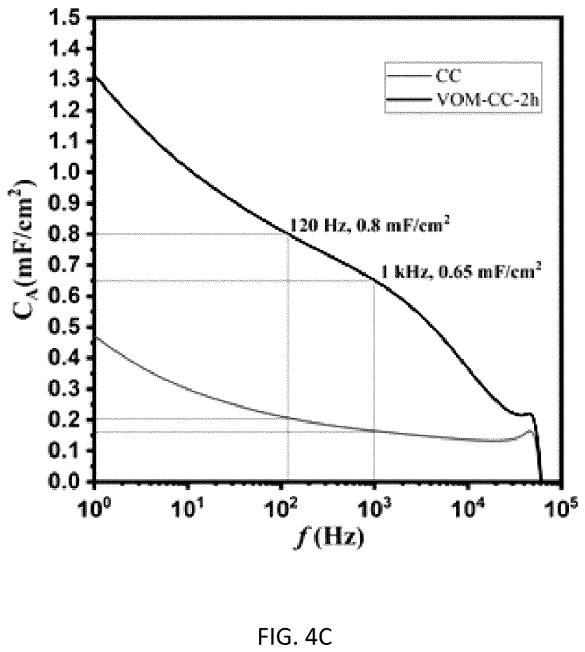

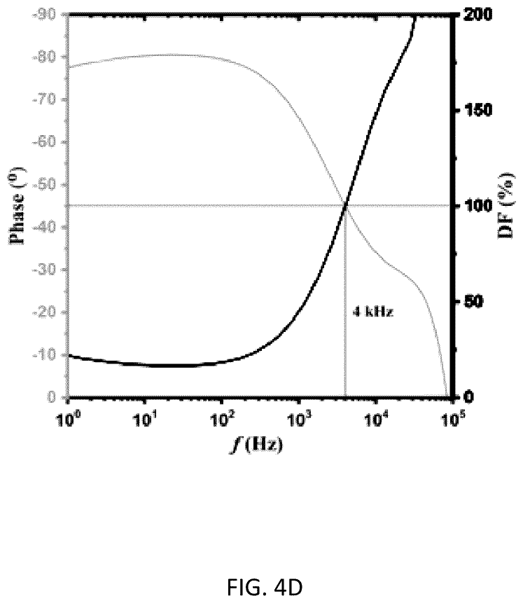

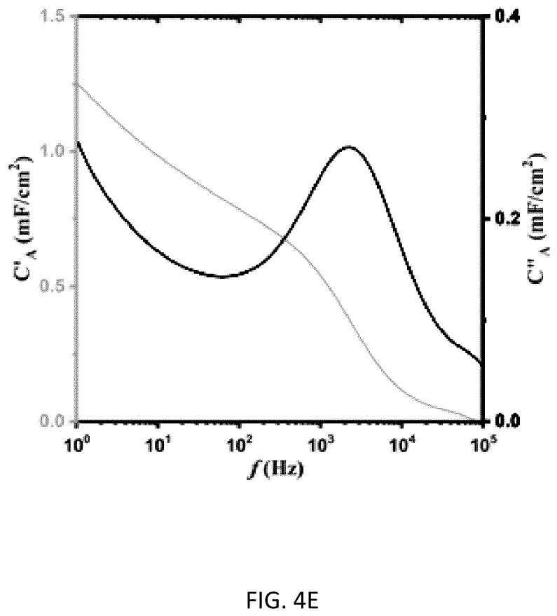

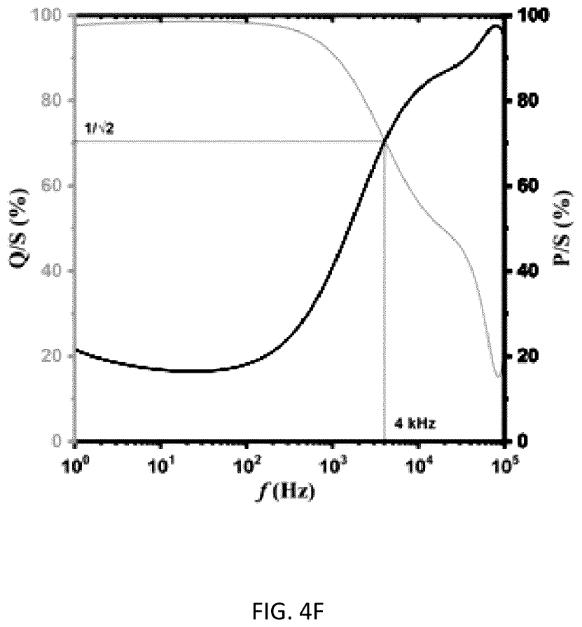

FIGS. 4A-4F are various plots and spectra characterizing a specific embodiment of a high-frequency electrochemical capacitor 200 with carbonized cellulose fiber electrodes 100 and an aqueous electrolyte 202. Specifically, FIGS. 4A and 4B show the EIS spectra of a CC cell and a VOM-CC-2h cell in Nyquist plot and Bode plot, respectively. FIG. 4C shows the derived areal capacitance density for the cell. FIGS. 4D, 4E, and 4F show the frequency dependance of the VOM-CC-2h cell in terms of DF, complex capacitance, and Q/S with P/S, respectively

To analyze the electrode performance, 2016-type coin cells with symmetric electrodes were assembled using 6M KOH as the aqueous electrolyte. Electrochemical measurements were conducted using a Biologic SP-250 electrochemical workstation. Electrochemical impedance spectroscopy (EIS) was measured from 100 kHz to 0.1 Hz with a sinusoidal ac voltage of 10 mV amplitude. Cyclic voltammetry (CV) was carried out in the 0-0.8 V range for aqueous electrolyte cells.

Based on its open morphology and highly ion-accessible nanostructure, VOM-CC-2h was tested as the electrode for fabrication of HF-ECs. Cells with a symmetric two-electrode configuration were assembled inside coin cells with 6M KOH as the aqueous electrolyte. Electrochemical impedance spectroscopy (EIS) and cyclic voltammetry (CV) were conducted to evaluate the performance of the devices.

In the Nyquist impedance plot (FIG. 4A), both CC and VOM-CC based cells exhibit nearly vertical impedance spectra at low frequency range, behavior of a nearly ideal capacitor (i.e., a constant phase element with an ideality factor n=1) connected in series with a resistance or an equivalent series resistance (ESR), suggesting they can be approximately modelled as a simple RC circuit. From the inset expanded view in the high frequency range, the difference between the two cells can be identified. The CC cell maintains its nearly vertical spectrum characteristic, but VOM-CC cell shows a tiny semicircle feature, which is most likely caused by a rapid pseudocapacitive effect (and hence a small charge transfer resistance) on layered MoS₂ surface or by a small interfacial resistance between the electrode material and the current collector. This feature in the cell does not occur until a high frequency, defined as the knee frequency, which was measured to be ˜8.6 kHz. Therefore, the EIS spectrum of the VOM-CC cell can be modelled as a simple RC circuit below this frequency.

The Bode plots of the EIS spectra are shown in FIG. 4B. The areal capacitance of the whole cell was derived from EIS using:

$${C}_{A} = \frac{- 1}{2 π f * {Z}^{″} ( f ) * A} \qquad ( 1 )$$

where A is the single electrode area. The capacitance is plotted in FIG. 4C. The CC cell exhibits an absolute phase angle (Q) more than 80° at a few kHz frequencies, but this angle decreases as the frequency is reduced. This phenomenon was caused by the micropores formed in the carbon fibers during the carbonization process, as confirmed by the enlarged capacitance at low frequencies (FIG. 4C). The rapid carbonization process can largely reduce the micropore density and volume but cannot eliminate them. In contrast, the absolute phase angle of VOM-CC at low frequencies is better than CC. This is because the deposited VOM on CC can block those micropores in CC. An absolute phase angle of ˜ 80° was obtained at 120 Hz for the VOM-CC cell. The −45° phase angle frequency (f₀) is found to be 4 kHz for the VOM-CC cell, as compared to 50 kHz observed for the CC cell. f₀ is reduced in the case of VOM-CC with growth of the VOM nanostructure; however, VOM nanostructure dramatically increases the areal capacitance density (CA) of the cell. A large capacitance of 0.8 mF/cm² at 120 Hz and 0.65 mF/cm² at 1 KHz were obtained for the VOM-CC-2h electrode-based cell, in compared to the 0.2 mF/cm² at 120 Hz and 0.15 mF/cm² at 1 kHz for the CC cell. The capacitance densities reported here, from electrodes fabricated in a facile process, are aligned with the state-of-the-art that commonly involves a complex fabrication process.

For a practical filtering capacitor, loss tangent (tanδ=Z′/|Z″|) and the corresponding dissipation factor (DF=tanδ×100%) are crucial parameters evaluating the ratio of resistive power over reactive power of the capacitor, which ideally should have a small value in high-power applications. As shown in FIG. 4D, up to ˜500 Hz, the VOM-CC cell has a DF below 25%. It reaches 100% at f₀=4 kHz when the resistive impedance equals the capacitive impedance. Above f₀ (f₀=1/2πRC), the resistive impedance is more than the capacitive impedance, and the cell behaves as a highly loss capacitor. The phase angle is negative until a frequency fₘₐₓ=1/2π\sqrt{LC}, where L is the parasitic inductance of the cell at this frequency. Above fₘₐₓ, the cell will behave as an inductor, not a capacitor anymore. In the case of the VOM-CC-2h cell, fₘₐₓ=˜80 kHz. Therefore, between f₀=4 kHz and fₘₐₓ=˜80 kHz, this cell could still be used as a filtering capacitor, although its DF will be much larger in this high frequency range.

The concept of a complex capacitance can be introduced for further analysis of an EC with resistive losses, which is defined as:

$${C}_{C} ( ω ) = {C}^{′} ( ω ) - j {C}^{″} ( ω ) = \frac{1}{j ω Z} = \frac{- {Z}^{″} - j {Z}^{′}}{ω {\vert Z \vert}^{2}} \qquad ( 2 )$$

and hence

$${C}^{′} ( ω ) = \frac{- {Z}^{″}}{ω {\vert Z \vert}^{2}} = - \frac{sin φ}{ω \vert Z \vert} , {C}^{″} ( ω ) = \frac{- {Z}^{′}}{ω {\vert Z \vert}^{2}} = \frac{cos φ}{ω \vert Z \vert} \qquad ( 3 )$$

where φ is the phase angle of the impedance, C′(ω) is the capacitance, and C″(ω) is associated with energy dissipation due to internal loss. In the case of an ideal blocking electrode-based EC with a capacitance C and a resistance R, its complex capacitance is:

$${C}^{′} ( ω ) = \frac{C}{1 + {( ω RC )}^{2}} , {C}^{″} ( ω ) = \frac{ω {RC}^{2}}{1 + {( ω RC )}^{2}} \qquad ( 4 )$$

where C″ arrives its resonant maximum at the characteristic frequency f₀, and at this frequency, C′(ω₀)=C/2.

In FIG. 4E, the VOM-CC-2h cell is analyzed based on the complex capacitance. The derived capacitance CA has a value very close to the capacitance in FIG. 4C. A resonant frequency of ˜2.5 kHz was found, which is also close to the f₀=4 kHz derived from FIG. 4B. The difference is caused by the non-ideal blocking electrode property of VOM-CC electrodes.

Treating the nonideal EC as a load powered by a sinusoidal source V(ω) with an amplitude of Vₘ, the real power P, the reactive power Q, and the apparent power S can be derived from the complex power S, defined as:

$$S = P = j Q = \frac{1}{2} {VI}^{*} \qquad ( 5 )$$

where V and I are the voltage and current phasors, respectively. From impedance definition, Z=

$$\frac{V}{I} = \frac{{V}_{m}}{{I}_{m}} ∠φ = \vert Z \vert ∠φ ,$$

we have

$$S = \frac{{V}_{m}^{2}}{2 \vert Z \vert} ∠φ = \frac{{V}_{m}^{2}}{2 \vert Z \vert} cos φ + j \frac{{V}_{m}^{2}}{2 \vert Z \vert} sin φ \qquad ( 6 )$$

and hence,

$$P = \frac{{V}_{m}^{2}}{2 \vert Z \vert} cos φ = \frac{{V}_{m}^{2}}{2} ω {C}^{″} \qquad ( 7 )$$

$$Q = \frac{{V}_{m}^{2}}{2 \vert Z \vert} sin φ = - \frac{{V}_{m}^{2}}{2} ω {C}^{′} \qquad ( 8 )$$

$$S = \frac{{V}_{m}^{2}}{2 \vert Z \vert} \qquad ( 9 )$$

For a HF-EC, since its capacitance dominates at low frequencies and resistance dominates at high frequencies, the normalized power P/S and the normalized reactive power |Q|/S will have a value between 0 and 1. When these two normalized powers equal, φ=45° and the normalized power will be 1/\sqrt{2}. It is further noticed that the dissipation factor:

$$DF = \frac{P}{\vert Q \vert} \times 100 \% = \frac{{C}^{″}}{{C}^{′}} \times 100 \% \qquad ( 10 )$$

In FIG. 4F, P/S and |Q|/S are plotted against the frequency, and again, f₀ of 4 kHz at φ=45° was derived.

Long-term cycling stability is another parameter of filtering ECs. Galvanostatic charge-discharge tests were conducted under a high current density of 10 mA cm⁻² after the freshly-made cell was stabilized to passivate the surface-related reactions. The cell capacitance retention, coulombic efficiency, and charge/discharge profile were examined. After surface passivation, the capacitance exhibited high stability and remained almost constant. After the 1×10⁶ fully charging-discharging cycles, the capacitance retention was above 98% of the initial value. The outstanding cycling stability of the contemplated VOM-CC freestanding electrodes confirms the chemical and structural stability of MoS₂ nanosheets and CC scaffold, as well as the strong bonding between them.

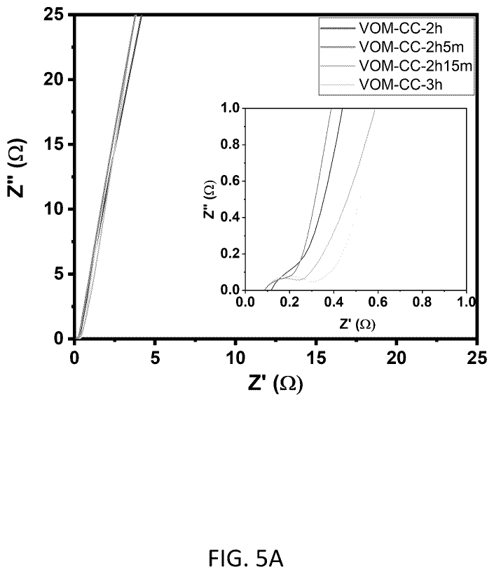

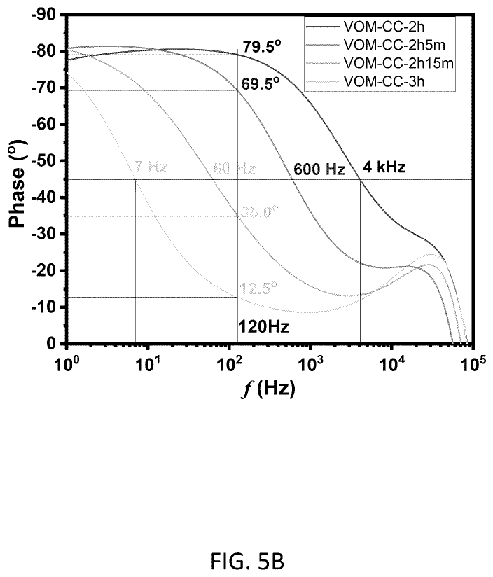

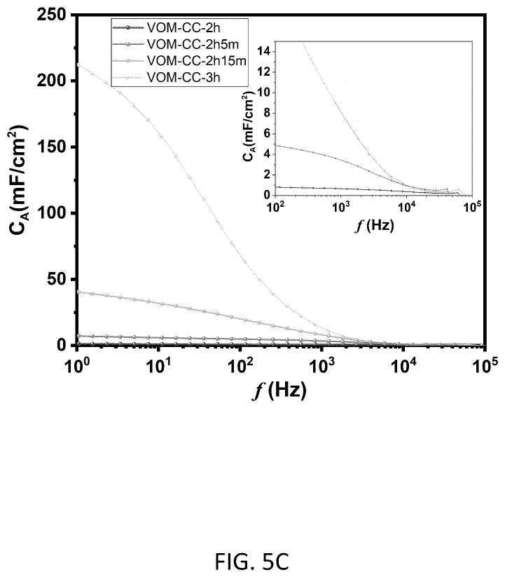

FIGS. 5A-5C are plots characterizing specific embodiments of the carbonized cellulose fiber electrode 100 made with various hydrothermal durations 124. Specifically, FIGS. 5A, 5B, and 5C show the EIS spectra of a set of VOM-CC samples in a Nyquist plot, Bode plot, as well as the derived cell capacitance density, respectively.

The EC cell performance was also tested based on the length of time spent in the hydrothermal reaction (i.e., the hydrothermal duration 124). A set of VOM-CC samples was prepared by varying MoS₂ hydrothermal durations 124, with samples for hydrothermal durations 124 of 2 h, 2h5m, 2h15m, and 3 h. Their complex impedance Nyquist plot is shown in FIG. 5A. As more MoS₂ nanoflakes were deposited, the porous effect and the interface resistance effect became more significant, giving rise to the more obvious Warburg region and semicircle features that caused a slower frequency response. From the phase plot (FIG. 5B), a progressive decrease in the frequency response of the electrode with increased deposition time can be seen. The cells based on the four samples exhibited 120 Hz phase angle of −79.5°, −69.5°, −35.0°, and −12.5°, and the characteristic frequency at −45° phase angle of 4k, 600, 60, and 7 Hz, respectively. The cell areal capacitance is plotted in FIG. 5C. At 1 Hz, VOM-CC-3h cell has a capacitance of ˜210 mF/cm². In particular, the VOM-CC-2h5m cell exhibits a 120 Hz phase angle of −69.5° and a remarkable capacitance of 4.8 mF/cm². Such a capacitor, with a lower frequency response but higher capacitance density, is suitable for pulse power applications at a low repetition rate.

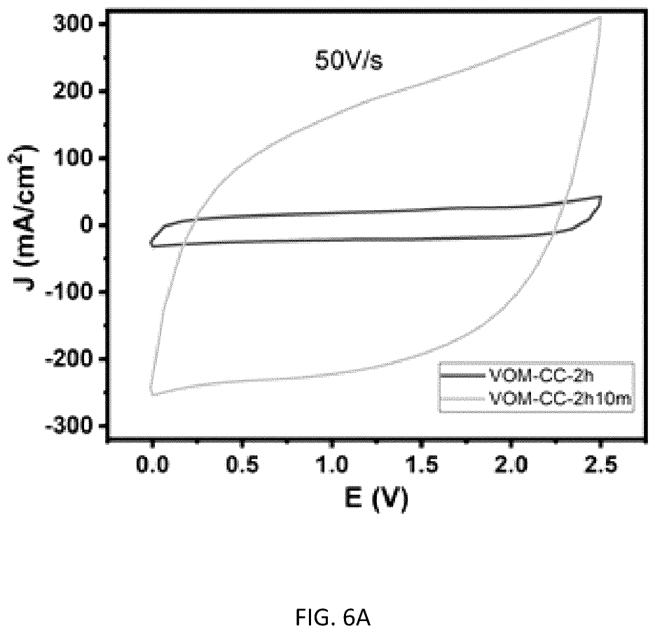

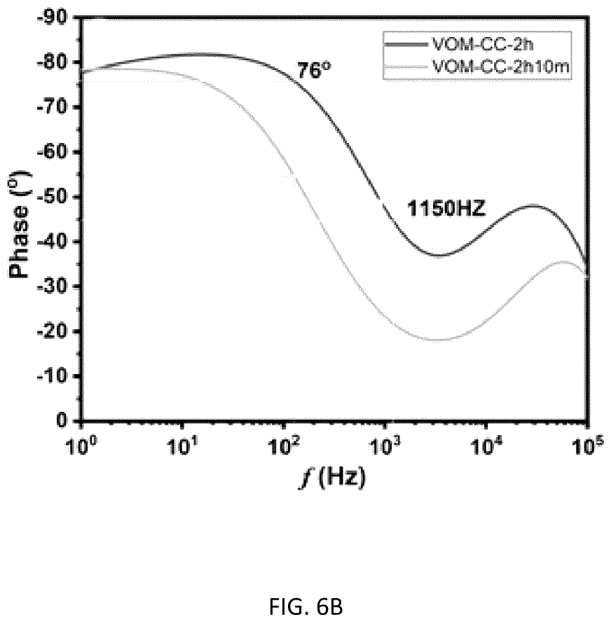

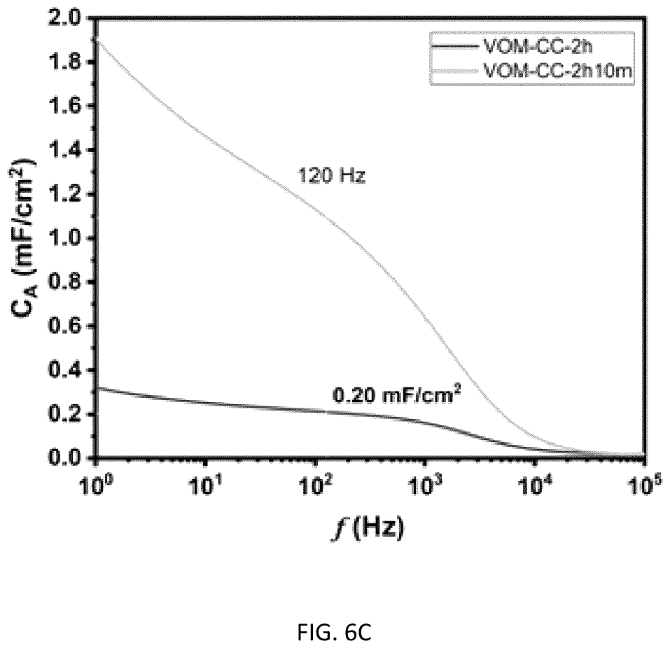

FIGS. 6A-6C are CV curves and plots characterizing a specific embodiment of a high-frequency electrochemical capacitor with carbonized cellulose fiber electrodes and an organic electrolyte. Specifically, FIGS. 6A, 6B, and 6C show CV curves at a scan rate of 50 V/s, a phase angle plot, and the derived capacitance of VOM-CC-2h and VOM-CC2h10m based organic cells, respectively.

To analyze the electrode performance, 2016-type coin cells with symmetric electrodes were assembled using 1M TEABF₄ in acetonitrile as the organic electrolyte. Electrochemical measurements were conducted using a Biologic SP-250 electrochemical workstation. Electrochemical impedance spectroscopy (EIS) was measured from 100 kHz to 0.1 Hz with a sinusoidal ac voltage of 10 mV amplitude. Cyclic voltammetry (CV) was carried out in the 0-2.5 V range for organic electrolyte cells.

The VOM-CC electrodes 100 were also tested in organic electrolyte cells using 1M TEABF₄ in acetonitrile as the electrolyte 202. The operable voltage window of an aqueous cell is restricted to below 0.8 V, while TEABF₄/ACN has a wide voltage window of 2.5V. CV and EIS tests were conducted to evaluate the performance of VOM-CC-2h and VOM-CC-2h 10m based cells.

CV curves were acquired from 0V to 2.5V for a range of scan rates from 1V/s to 50V/s. In FIG. 6A, the CV curve is plotted at 50V/s for comparison. The rectangular nature of the CV profile was maintained at 50V/s even for the VOM-CC-2h10m cell. For these two cells the calculated cell capacitance at 50V/s is 0.4 and 3.3 mF/cm², respectively. The EIS derived plots are shown in FIGS. 6B and 6C. Admittedly, their capacitance (i.e., 0.20 mF/cm², 76°, and 1.2 mF/cm², 54° at 120 Hz) and frequency response (i.e., f₀=1150, 220 Hz) are lower than that of the corresponding aqueous electrolyte cells. This loss in frequency response was caused by the reduced ion diffusion and migration rates because of bulkier ions with larger inertia for TEABF₄, while the larger ion size also restricts ion accessibility to the smaller pores, limiting the capacitance.

Even though these organic ECs have a slower frequency response than their aqueous counterparts, their speed is still much higher than conventional ECs. Since the contemplated freestanding carbonized cellulose fiber electrode 100 is thin (i.e., ˜10 μm), these organic ECs were expected to have both high energy and high power densities. For the VOM-CC-2h10m cell, if only the volume of the two electrodes is considered, the calculated energy density and power density for this cell are 0.36 mWh/cm³ and 26 W/cm³ at 50V/s. This power density is similar to AECs, but AECs have an energy density in the range of μWh cm 3, much smaller than these carbonized cellulose fiber-based electrochemical capacitors 200. The energy and power densities calculated here imply that the VOM-CC based ECs can operate in practical cases where high energy storage and rapid release are needed.

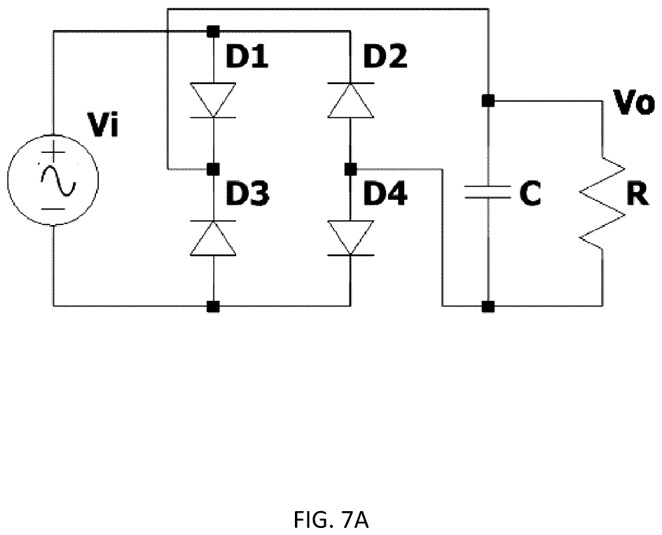

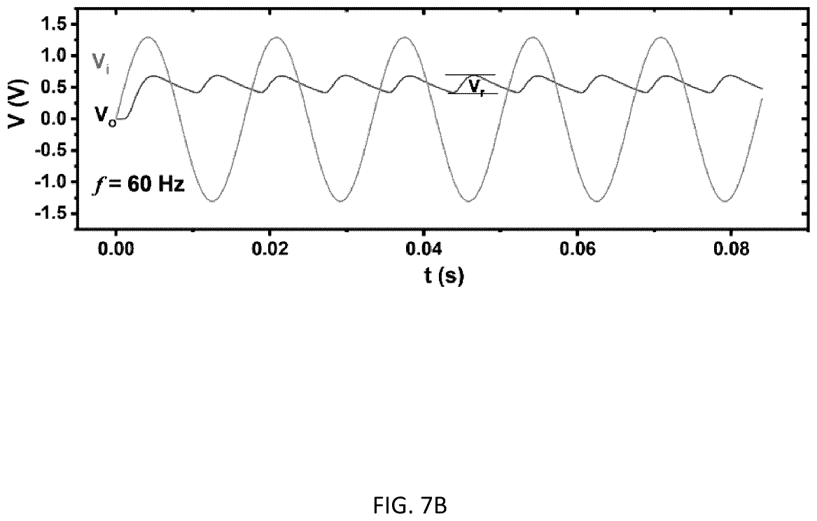

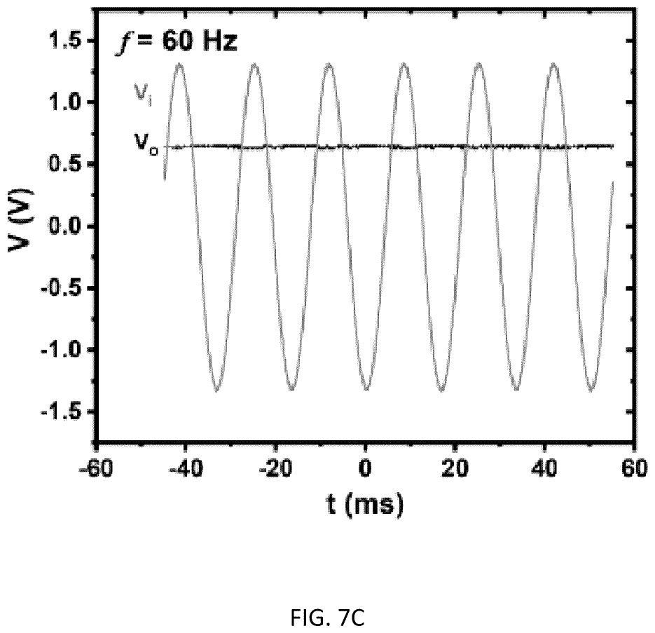

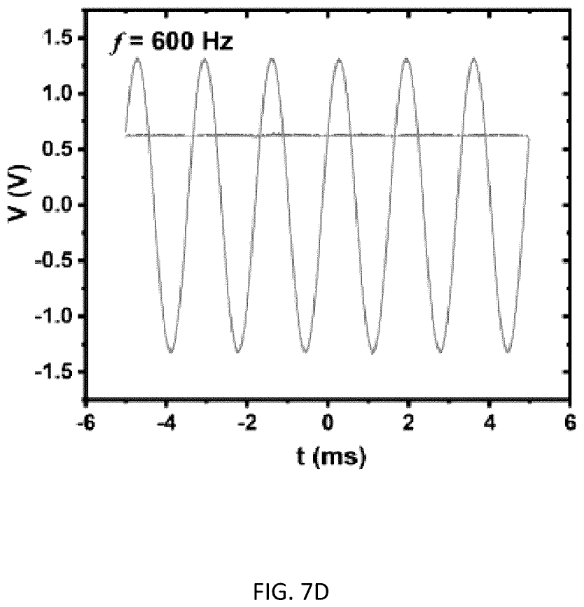

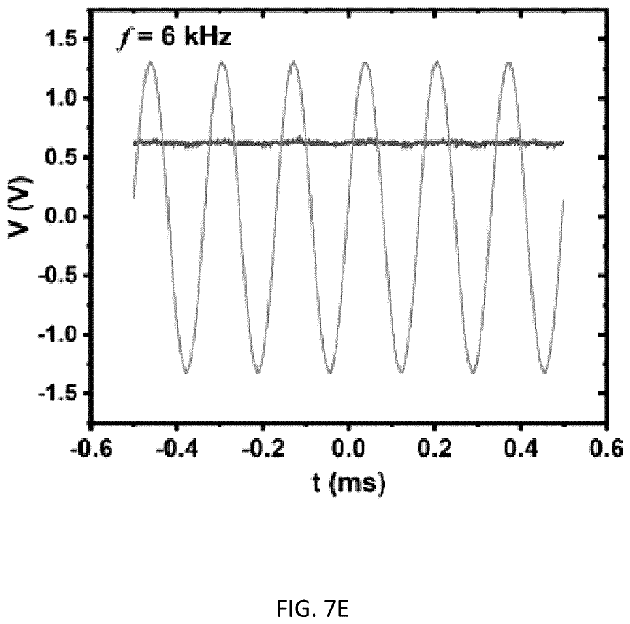

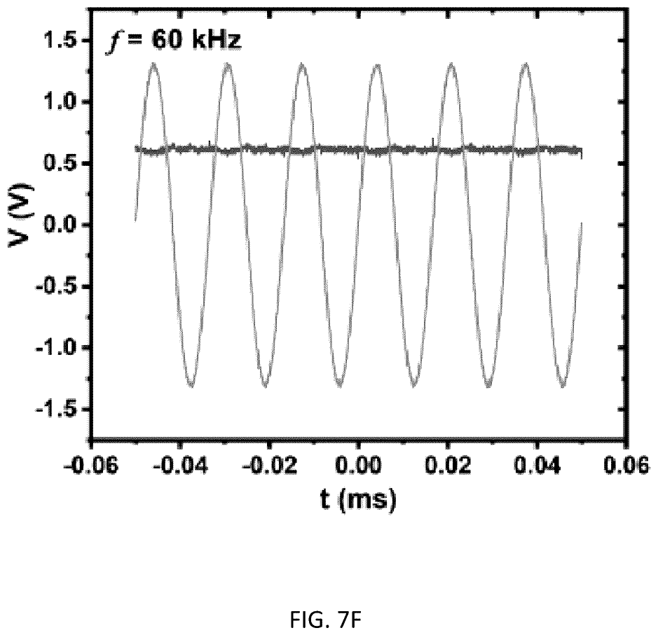

FIG. 7A is a schematic view of an AC/DC full-wave conversion circuit using an HF-EC as the filtering capacitor. FIG. 7B shows a simulation result of a regular ripple pattern. FIGS. 7C-7F show the measured load voltage after EC filtering for a sinusoidal input at different frequencies.

As proof of concept, the application of the contemplated kHz ECs 200 for ripple filtering in AC/DC conversion is demonstrated. The full wave conversion circuit is shown in FIG. 7A, with D1-D4 as the diodes, C as the filtering capacitor and R the load. FIG. 7B shows the input sinusoidal wave Vᵢ with frequency f and the output Vₒ with a ripple voltage Vᵣ, which is given by:

Vᵣ≈Vₒ/2fCR (11)

This equation indicates that for a given load R, the ripple voltage is inversely proportional to both f and C. Although the capacitance of an EC decreases with frequency, from FIG. 4E, the multiplication of fC in fact increases with frequency, and therefore, the phase angle is still negative (or C>0), the ripple voltage will not increase. This suggests that at least for sinusoidal waves, up to its resonant frequency fₘₐₓ where the effective capacitance becomes null, the EC can be used for ripple filtering. For non-sinusoidal waves, the high order harmonic components with frequencies above fₘₐₓ will enhance the ripple.

FIGS. 7C-F present the filtered DC voltage on the load R (i.e., 500 kΩ using the VOM-CC-2h based EC 200, with fₘₐₓ ˜80 kHz, for the input sinusoidal wave with a frequency from 60 Hz to 60 kHz. There is no obvious ripple component on the load. The observed noise most likely is associated with the measurement itself, but not with the ripple which has a regular pattern. Not shown here, when the frequency of the input wave is above 100 kHz, the EC loses its filtering function.

It will be understood that implementations are not limited to the specific components disclosed herein, as virtually any components consistent with the intended operation of carbonized cellulose fiber electrodes for high-frequency electrochemical capacitors and method for fabricating the same may be utilized. Accordingly, for example, although particular systems, methods, and/or devices for electrodes, cellulose fiber substrate, vertically oriented nanoflakes, hydrothermal solution, and electrochemical capacitors may be disclosed, such components may comprise any shape, size, style, type, model, version, class, grade, measurement, concentration, material, weight, quantity, and/or the like consistent with the intended operation of carbonized cellulose fiber electrodes for high-frequency electrochemical capacitors and method for fabricating the same may be used. In places where the description above refers to particular implementations of carbonized cellulose fiber electrodes for high-frequency electrochemical capacitors and method for fabricating the same, it should be readily apparent that a number of modifications may be made without departing from the spirit thereof and that these implementations may be applied to other high-frequency electrodes. [De]

### REFERENCES

ADDIN EN.REFLIST 1. Miller, J. R.; Outlaw, R.; Holloway, B. Graphene double-layer capacitor with ac line-filtering performance. Science 2010, 329, 1637-1639.
2. Fan, Z.; Islam, N.; Bayne, S. B. Towards kilohertz electrochemical capacitors for filtering and pulse energy harvesting. Nano Energy 2017, 39, 306-320.
3. Park, J.; Kim, W. History and perspectives on ultrafast supercapacitors for AC line filtering. Advanced Energy Materials 2021, 11, 2003306.
4. Sheng, K.; Sun, Y.; Li, C.; Yuan, W.; Shi, G. Ultrahigh-rate supercapacitors based on eletrochemically reduced graphene oxide for ac line-filtering. Scientific reports 2012, 2, 1-5.
5. Wu, M.; Chi, F.; Geng, H.; Ma, H.; Zhang, M.; Gao, T.; Li, C.; Qu, L. Arbitrary waveform AC line filtering applicable to hundreds of volts based on aqueous electrochemical capacitors. Nature communications 2019, 10, 1-9.
6. Zhao, D.; Jiang, K.; Li, J.; Zhu, X.; Ke, C.; Han, S.; Kymakis, E.; Zhuang, X. Supercapacitors with alternating current line-filtering performance. BMC Materials 2020, 2, 1-20.
7. Li, Z.; Zhao, L.; Zheng, X.; Lin, P.; Li, X.; Li, R.; Han, D.; Zhao, S.; Lv, D.; Wang, L. Continuous PEDOT: PSS nanomesh film: Towards aqueous AC line filtering capacitor with ultrahigh energy density. Chemical Engineering Journal 2022, 430, 133012.
8. Wang, F.; Guo, Z.; Wang, Z.; Zhu, H.; Zhao, G.; Chen, C.; Liu, M.; Sun, R.; Kang, F.; Wong, C. P. Laser-Induced Transient Self-Organization of TiNx Nano-Filament Percolated Networks for High Performance Surface-Mountable Filter Capacitors. Advanced Materials 2023, 35, 2210038.
9. Wu, M.; Chi, F.; Geng, H.; Ma, H.; Zhang, M.; Gao, T.; Li, C.; Qu, L. Arbitrary waveform AC line filtering applicable to hundreds of volts based on aqueous electrochemical capacitors. Nature Communications 2019, 10, 2855.
10. Han, F.; Qian, O.; Meng, G.; Lin, D.; Chen, G.; Zhang, S.; Pan, Q.; Zhang, X.; Zhu, X.; Wei, B. Structurally integrated 3D carbon tube grid-based high-performance filter capacitor. Science 2022, 377, 1004-1007.
11. Ren, G.; Li, S.; Fan, Z.-X.; Hoque, M. N. F.; Fan, Z. Ultrahigh-rate supercapacitors with large capacitance based on edge oriented graphene coated carbonized cellulous paper as flexible freestanding electrodes. Journal of Power Sources 2016, 325, 152-160.
12. Bissett, M. A.; Worrall, S. D.; Kinloch, I. A.; Dryfe, R. A. Comparison of two-dimensional transition metal dichalcogenides for electrochemical supercapacitors. Electrochimica Acta 2016, 201, 30-37.
13. De Adhikari, A.; Shauloff, N.; Turkulets, Y.; Shalish, I.; Jelinek, R. Tungsten-Disulfide/Polyaniline High Frequency Supercapacitors. Advanced Electronic Materials 2021, 7, 2100025.
14. Tamgadge, R. M.; Kumar, S.; Shukla, A. A kilohertz frequency response pseudocapacitor. Journal of Power Sources 2020, 465, 228242.
15. Morag, A.; Maman, N.; Froumin, N.; Ezersky, V.; Rechav, K.; Jelinek, R. Nanostructured Nickel/Ruthenium/Ruthenium-Oxide Supercapacitor Displaying Exceptional High Frequency Response. Advanced Electronic Materials 2020, 6, 1900844.
16. Islam, N.; Li, S.; Ren, G.; Zu, Y.; Warzywoda, J.; Wang, S.; Fan, Z. High-frequency electrochemical capacitors based on plasma pyrolyzed bacterial cellulose aerogel for current ripple filtering and pulse energy storage. Nano Energy 2017, 40, 107-114.
17. Quilty, C. D.; Housel, L. M.; Bock, D. C.; Dunkin, M. R.; Wang, L.; Lutz, D. M.; Abraham, A.; Bruck, A. M.; Takeuchi, E. S.; Takeuchi, K. J. Ex situ and operando XRD and XAS analysis of MoS₂: a lithiation study of bulk and nanosheet materials. ACS Applied Energy Materials 2019, 2, 7635-7646.
18. Saber, M. R.; Khabiri, G.; Maarouf, A. A.; Ulbricht, M.; Khalil, A. S. A comparative study on the photocatalytic degradation of organic dyes using hybridized 1T/2H, 1T/3R and 2H MOS 2 nano-sheets. RSC advances 2018, 8, 26364-26370.
19. Saseendran, S. B.; Ashok, A.; Asha, A. Edge terminated and interlayer expanded pristine MoS₂ nanostructures with 1T on 2H phase, for enhanced hydrogen evolution reaction. International Journal of Hydrogen Energy 2022, 47, 9579-9592.
20. Acerce, M.; Voiry, D.; Chhowalla, M. Metallic 1T phase MoS₂ nanosheets as supercapacitor electrode materials. Nature nanotechnology 2015, 10, 313-318.
21. Krishnamoorthy, K.; Veerasubramani, G. K.; Radhakrishnan, S.; Kim, S. J. Supercapacitive properties of hydrothermally synthesized sphere like MoS₂ nanostructures. Materials Research Bulletin 2014, 50, 499-502.
22. He, H.; Li, X.; Huang, D.; Luan, J.; Liu, S.; Pang, W. K.; Sun, D.; Tang, Y.; Zhou, W.; He, L. Electron-injection-engineering induced phase transition toward stabilized 1T-MoS₂ with extraordinary sodium storage performance. ACS nano 2021, 15, 8896-8906.
23. Li, H.; Tsai, C.; Koh, A. L.; Cai, L.; Contryman, A. W.; Fragapane, A. H.; Zhao, J.; Han, H. S.; Manoharan, H. C.; Abild-Pedersen, F. Activating and optimizing MoS₂ basal planes for hydrogen evolution through the formation of strained sulphur vacancies. Nature materials 2016, 15, 48-53.
24. Qin, P.; Fang, G.; Ke, W.; Cheng, F.; Zheng, Q.; Wan, J.; Lei, H.; Zhao, X. In situ growth of double-layer MoO 3/MoS 2 film from MoS 2 for hole-transport layers in organic solar cell. Journal of Materials Chemistry A 2014, 2, 2742-2756.
25. Qiao, Y.; Hu, X.; Liu, Y.; Liang, G.; Croft, M. C.; Huang, Y. Surface modification of MoO x S y on porous TiO 2 nanospheres as an anode material with highly reversible and ultrafast lithium storage properties. Journal of Materials Chemistry A 2013, 1, 15128-15134.
26. Nandi, D. K.; Sahoo, S.; Sinha, S.; Yeo, S.; Kim, H.; Bulakhe, R. N.; Heo, J.; Shim, J.-J.; Kim, S.-H. Highly uniform atomic layer-deposited MoS2@3D-Ni-foam: a novel approach to prepare an electrode for supercapacitors. ACS applied materials & interfaces 2017, 9, 40252-40264.
27. Sun, T.; Li, Z.; Liu, X.; Ma, L.; Wang, J.; Yang, S. Facile construction of 3D graphene/MoS₂ composites as advanced electrode materials for supercapacitors. Journal of Power Sources 2016, 331, 180-188.
28. Altavilla, C.; Sarno, M.; Ciambelli, P. A Novel Wet Chemistry Approach for the Synthesis of Hybrid 2D Free-Floating Single or Multilayer Nanosheets of MS2@ oleylamine (MI Mo, W). Chemistry of Materials 2011, 23, 3879-3885.
29. Hussain, S.; Singh, J.; Vikraman, D.; Singh, A. K.; Iqbal, M. Z.; Khan, M. F.; Kumar, P.; Choi, D.-C.; Song, W.; An, K.-S. Large-area, continuous and high electrical performances of bilayer to few layers MoS₂ fabricated by RF sputtering via post-deposition annealing method. Scientific reports 2016, 6, 30791.
30. Li, W.; Azam, S.; Dai, G.; Fan, Z. Prussian blue based vertical graphene 3D structures for high frequency electrochemical capacitors. Energy Storage Materials 2020, 32, 30-36.

What is claimed is:

1. A method for making an electrode, comprising:
carbonizing a cellulose fiber substrate by subjecting the cellulose fiber substrate to a rapid pyrolysis process in a preheated furnace having an inert environment at a pyrolysis temperature of at least 1000° C., resulting in a carbonized cellulose substrate;
preparing a hydrothermal solution;
depositing vertically oriented nanoflakes on the carbonized cellulose substrate by immersing the carbonized cellulose substrate in the hydrothermal solution and conducting a hydrothermal reaction, thereby forming the electrode.

2. The method of claim 1, wherein the vertically oriented nanoflakes are composed of a transition metal dichalcogenide.

3. The method of claim 2, wherein the transition metal dichalcogenide is MoS₂.

4. The method of claim 3, wherein the hydrothermal solution is prepared by dissolving sodium molybdate dihydrate and thiourea in deionized water, and wherein the hydrothermal reaction is conducted at a hydrothermal temperature of at least 220° C. for a hydrothermal duration between 2 and 3 hours.

5. The method of claim 1, wherein the cellulose fiber substrate is a cellulose tissue sheet.

6. The method of claim 1, wherein the cellulose fiber substrate is subjected to the rapid pyrolysis process for a pyrolysis duration of less than 20 minutes with the pyrolysis temperature above 1000° C.

7. The method of claim 1, wherein the electrode is freestanding.

8. The method of claim 1, wherein the electrode is at most 10 μm thick.

9. The method of claim 1, wherein the vertically oriented nanoflakes are composed of a transition metal oxide.

10. The method of claim 1, wherein the vertically oriented nanoflakes are composed of one of a transition metal nitride and a 2D MXene.

11. The method of claim 1, wherein the vertically oriented nanoflakes are composed of graphene.

12. The method of claim 1, wherein the vertically oriented nanoflakes are composed of carbon black.

13. An electrochemical capacitor, comprising:
at least two electrodes, each comprising vertically oriented nanoflakes deposited on a carbonized cellulose substrate; and
an electrolyte positioned between each pair of the at least two electrodes.

14. The electrochemical capacitor of claim 13, wherein the electrodes have an areal capacitance density of at least 0.8 mF/cm² at 120 Hz.

15. The electrochemical capacitor of claim 13, wherein the vertically oriented nanoflakes are composed of a transition metal dichalcogenide.

16. The electrochemical capacitor of claim 15, wherein the transition metal dichalcogenide is MoS₂.

17. The electrochemical capacitor of claim 13, wherein the vertically oriented nanoflakes are composed of a transition metal oxide.

18. The electrochemical capacitor of claim 13, wherein the vertically oriented nanoflakes are composed of one of a transition metal nitride and a 2D MXene.

19. The electrochemical capacitor of claim 13, wherein the electrolyte is an aqueous electrolyte.

20. The electrochemical capacitor of claim 13, wherein the electrolyte is an organic electrolyte.
